(19) United States
(12) Patent Application Publication
(10) Pub. No.: US 2025/0357861 A1
(43) Pub. Date: Nov. 20, 2025

(54) PHASE CONTROLLER OF A SWITCHING CONVERTER MEASURING LOAD-CURRENT UNDER LIGHT LOAD

(71) Applicant: Shaoxing Yuanfang Semiconductor Co., Ltd., Shaoxing (CN)

(72) Inventors: Anil Narayan Kakade, Bangalore (IN); Subhash Sahni, Bangalore (IN); Suresh Venkatesan, Bangalore (IN); Ramkishore Ganti, Bangalore (IN)

(21) Appl. No.: 19/181,332

(22) Filed: Apr. 17, 2025

(30) Foreign Application Priority Data
May 15, 2024 (IN) 202441038232

(51) Int. Cl. H02M 3/158; H02M 1/00; H02M 1/084; H02M 3/157

(52) U.S. Cl. CPC H02M 3/158; H02M 1/0009; H02M 1/0845; H02M 3/157

(57) ABSTRACT

A multi-phase switching converter provided according to an aspect of the present disclosure includes a power stage and a phase controller, and provides a regulated supply voltage from an input voltage in a light load condition. The power stage receives a phase control signal and drives an inductor to cause flow of an inductor-current according to the phase control signal, wherein a load-current of the multi-phase switching converter is formed from the inductor-current. The phase controller receives a current signal from the power stage at a pin, the current signal being in an analog continuous form to represent the inductor-current in the power stage. The phase controller integrates the current signal in the analog continuous form to generate a voltage-output representing a magnitude of the load-current, and determines the magnitude of load-current based on the voltage-output.

### PRIORITY CLAIM

The instant patent application is related to and claims priority from the co-pending provisional India patent application entitled, “An accurate method to measure low load currents in AOT (adaptive ON-time) DC-DC converters”, Serial No. 202441038232, Filed: 15 May 2024; Attorney docket no.: AURA-361-INPR, which is incorporated in its entirety herewith to the extent not inconsistent with the description herein.

### BACKGROUND

### Technical Field

Embodiments of the present disclosure relate generally to switching converters, and more specifically to measurement of load-current in switching converters under light load.

### Related Art

Switching converters refer to components which convert an input AC (alternating current) or DC (direct current) voltage of one magnitude to an output DC voltage of a desired magnitude, as is well known in the relevant arts. Switching converters find use as, for example, stand-alone power supplies, in voltage regulator modules used in several environments such as laptops, mobile phones, etc.

A switching converter often employs multiple power stages, in combination with a phase controller. The phase controller provides control signals to each of the power stages to cause the power stages to generate the requisite load-current. Each active power stage is driven to generate a corresponding part of the requisite load-current in a respective phase of a sequence of phases, and thus such a switching converter is referred to as a multi-phase switching converter.

Switching converters are often operated under light load conditions. A light load condition is characterized in that the load current requirement is small (i.e., a small portion, say less than 10% of the maximum rated power). It is generally desirable to operate switching converters with high efficiency even under light load conditions.

One requirement in obtaining such high efficiency is that the load-current is to be measured accurately, which information is thereafter used by the phase controller to drive the power stages. However, accurate measurement of load-current in light load conditions may present challenges given that the rated total range of load-current is many-fold wider than that in the light load condition alone.

Aspects of the present disclosure are directed to measurement of load-current in switching converters under light load.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a voltage regulation module (VRM) in an embodiment of the present disclosure.

FIG. 3A is a diagram illustrating the implementation details of a power stage in an embodiment of the present disclosure.

FIG. 3B is a flow-chart illustrating the manner in which load-current is measured in a phase controller, in an embodiment of the present disclosure.

FIG. 4A is a diagram illustrating the implementation details of a phase controller, in an embodiment of the present disclosure.

FIG. 4B is a diagram illustrating the implementation details of a current measurement block, in an embodiment of the present disclosure.

FIG. 5 is a timing diagram illustrating the manner in which load-current is measured based on current signals received from power stages, in an embodiment of the present disclosure.

FIG. 6 is a diagram illustrating the implementation details of differential gain stage of a transconductance amplifier, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A multi-phase switching converter provided according to an aspect of the present disclosure includes a power stage and a phase controller, and provides a regulated supply voltage from an input voltage. The power stage receives a phase control signal and drives an inductor to cause flow of an inductor-current according to the phase control signal, wherein a load-current of the multi-phase switching converter is formed from the inductor-current. The phase controller receives a current signal from the power stage at a pin, the current signal being in an analog continuous form to represent the inductor-current in the power stage. The phase controller integrates the current signal in the analog continuous form to generate a voltage-output representing a magnitude of the load-current, and determines the magnitude of the load-current based on the voltage-output.

It may be appreciated that an accurate determination of the load-current can enable accurate determination of the characteristics (e.g., ON-time) of the phase control signal for obtaining maximum efficiency.

According to another aspect of the present disclosure, a master-control-signal generator block of the phase controller receives the regulated supply voltage, a reference voltage of a desired magnitude, and a magnitude of ON-time, and generates a common control signal with corresponding characteristics. A phase distributor of the phase controller receives the common control signal and generates the phase control signal timed according to the transitions of the common control signal. A current measurement block of the phase controller receives the current signal and determines the magnitude of the load-current.

According to another aspect of the present disclosure, the current measurement block contains an integrator block that receives the current signal and provides the voltage-output, and a processing block that receives the voltage-output, determines the magnitude of the ON-time based on the magnitude of the voltage-output, and provides the magnitude of the ON-time to the master-control-signal generator block.

In an embodiment, the current measurement block contains a first resistor coupled between the pin and the integrator block. The integrator block contains a transconductance amplifier characterized by a transconductance value (gm), the transconductance amplifier receiving a voltage-drop across the first resistor as a differential input and generating an output-current proportional to a magnitude of the voltage-drop, the voltage-drop caused due to flow of the current signal via the first resistor. The integrator block contains a capacitor having a first terminal and a second terminal, the capacitor characterized by a capacitance value, the capacitor receiving the output-current of the transconductance amplifier and providing the voltage-output at the first terminal, wherein the second terminal of the capacitor is connected to a reference voltage. A processing block of the current measurement block contains a comparator to compare a magnitude of a voltage at the first terminal of the capacitor with a threshold voltage, wherein the comparator asserts a reset-signal when the magnitude of the voltage at the first terminal falls below the threshold voltage, wherein the capacitor is discharged when the reset-signal is asserted. A counter of the processing block receives the reset-signal and generates a count of a number of times the reset-signal is asserted in a sampling window. A mapping block of the processing block receives the count and maps the count to a corresponding magnitude of the ON-time.

According to an aspect, the threshold voltage is proportional to a pre-determined quantum of change in magnitude of charge in said capacitor, and a duration of the sampling window is selected to be greater than the amount of time required for change in voltage at said first terminal of said capacitor by said threshold voltage.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

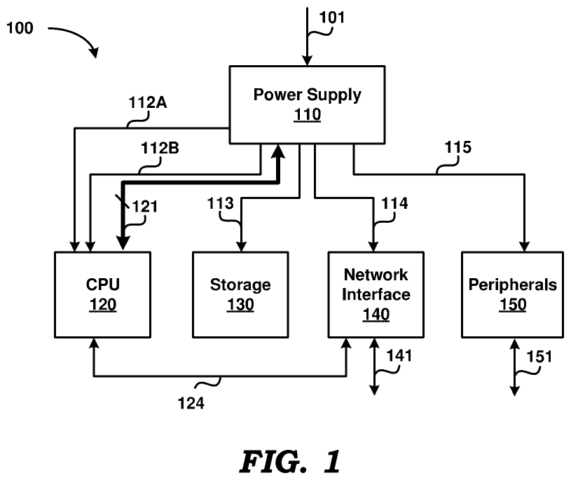

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in bidirectional path/bus 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”. CPU 120 receives health information of the power stages from phase controller 210 via bidirectional path/bus 121.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provided two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 receives signals from CPU 120 received on path 121 that may indicate power-modes in which CPU 120 is to operate in a particular duration, with the power-modes representing a magnitude of power that CPU 120 is likely to require/consume from power supply 110. Power supply 110 responds to the signals by controlling the multi-phase converter(s) to reduce/increase current output based on the specific power-mode signal (e.g., PS1, PS2 and PS3).

In an embodiment, power supply 110 is a voltage regulator module (VRM), sometimes also called processor power module (PPM), and contains one or more step-down switching (buck) converters to generate one or more smaller voltages from a higher-voltage supply source. In other embodiments however, other types of DC-DC converters such as boost, buck-boost, hysteretic converters etc., can be implemented instead of a buck converter. Further, power supply 110 can be implemented as a standalone switching converter with only one power stage (and therefore not be a multi-phase converter). With a VRM, multiple devices/ICs requiring different supply voltages can be mounted on the same platform, for example, a computer motherboard of a personal computer (PC).

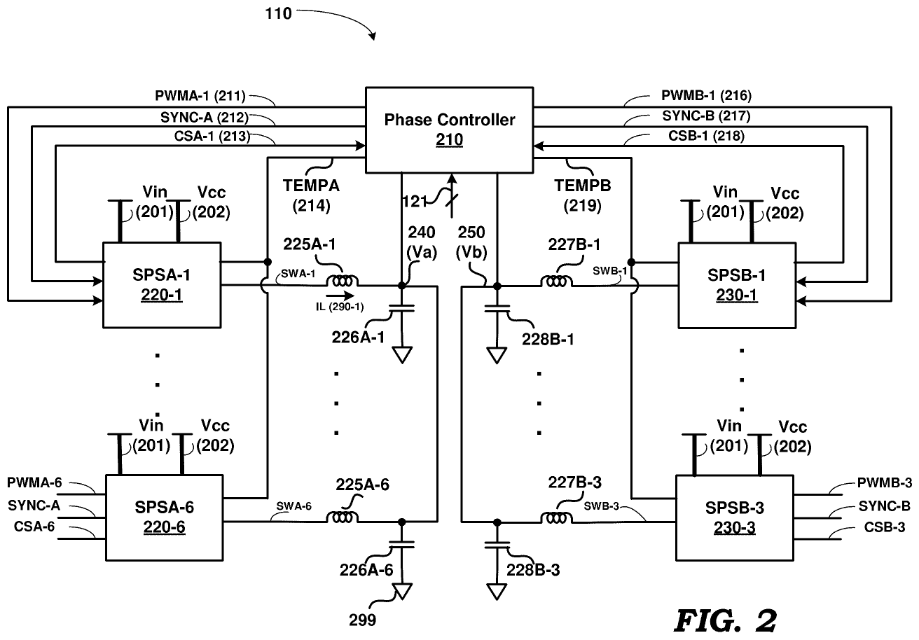

The description is continued with respect to the internal details of a VRM as shown in FIG. 2.

### 3. Voltage Regulator Module (VRM)

FIG. 2 is a block diagram illustrating the details of a VRM in an embodiment of the present disclosure. Power supply 110 (of FIG. 1) is a Voltage Regulator Module implemented in the form of a multi-phase switching converter generating two regulated power supplies (supply rails) Va (240) and Vb (250), and is shown containing phase controller 210, smart power stages (power stages) (SPS) SPSA-1 (220-1) through SPSA-6 (220-6), SPSB-1 (230-1) through SPSB-3 (230-3), inductors 225A-1 through 225A-6, 227B-1 through 227B-3, and output capacitors 226A-1 through 226A-6, 228B-1 through 228B-3. Node 299 represents ground terminal (0 Volts).

In the example, power supply Va (240) is generated by a 6-phase buck converter (there are six SPSs-220-1 through 220-6), while power supply Vb (250) is generated by a 3-phase buck converter (there are three SPSs-230-1 through 230-3). Nodes/Paths 240 and 250 correspond to paths 112A and 112B respectively of FIG. 1. In the interest of conciseness, other power supply circuits that generate supplies on paths 113, 114 and 115 are not shown in FIG. 2.

Power stages 220-1 through 220-6, and 230-1 through 230-3, may be generically referred below by respective numerals 220 and 230, as will be clear from the context. Also, signals/nodes 211-1 through 211-6, 213-1 through 213-6, 215-1 through 215-6, 216-1 through 216-3, 218-1 through 218-3 may be generically referred by respective numerals 211, 213, 215, 216 and 218, as will also be clear from the context. Similar convention is followed for other blocks/components/signals throughout the disclosure.

In an embodiment of the present disclosure, each of the power stages as well as the phase controller is implemented as separate integrated circuits (ICs). However, in other embodiments, the implementations of the power stages and phase controller may be different. The combination of (corresponding circuitry within) phase controller 210, a power stage, an inductor and a capacitor forms one “phase” of a multi-phase switching converter. Thus, for example, SPSA-1, inductor 225A-1, capacitor 226A-1, and the corresponding portion within phase controller 210 represent one phase of the 6-phase buck converter.

Each power stage may be implemented to contain a high-side switch, a low-side switch, gate-drive circuitry for the two switches, and other circuits. Examples of other circuits include, but are not limited to, temperature monitor circuit, inductor-current sense (or emulation) circuit, etc., to provide information, such as temperature of the SPS/power stage, magnitude of inductor-current, etc., to phase controller 210. Each SPS receives a source of power as an input which is connected to the high-side switch. In FIG. 2, the supply source is numbered 201, and has a voltage Vin. In an embodiment, the value of Vin is 12 Volts (V). Each SPS is also shown receiving a voltage Vcc on path 202. In an embodiment, Vcc has a voltage of 3.3 V, and is provided by phase controller 210.

Each SPS communicates with phase controller 210 via corresponding signals PWM, SYNC, CS and TEMP. Thus, SPSA-1 is shown connected to phase controller 210 through signal/paths PWMA-1 (211), SYNC-A (212), CSA-1 (213) and TEMPA (214). SPSA-6 communicates with phase controller 210 via signals PWMA-6, SYNC-A, CSA-6 and TEMPA (214), although in FIG. 2, the respective connections of signals PWMA-6, SYNC-A and CSA-6 to phase controller 210 are not shown. Similarly, SPSB-1 is shown connected to phase controller 210 through signal/paths PWMB-1 (216), SYNC-B (217), CSB-1 (218) and TEMPB (219). SPSB-3 communicates with phase controller 210 via signals PWMB-3, SYNC-B, CSB-3 and TEMPB (219), although in FIG. 2, the respective connections of signals PWMB-3, SYNC-A and CSB-3 to phase controller 210 are not shown. The other SPSs would have similar connections with phase controller 210. In other embodiments, there may be more or fewer numbers of such signals depending on the requirements of the specific operating environments.

Signal TEMP is an output from an SPS to phase controller 210, and provides information regarding the temperature in the SPS. Phase controller 210 may process the TEMP signal (or the information contained in it) to adjust the current supplied by that phase, or for shut-down of the VRM. The TEMP outputs of each phase of a converter are wired together, and a single input is connected to phase controller 210.

Signal CS (current-sense) is an input to phase controller 210 from an SPS/phase, and contains information regarding the instantaneous magnitude of the inductor-current of that phase. The information can be in the form of a current, voltage, digital values, etc., depending on the specific implementation of the power stages and phase controller 210. A CS block in an SPS implements the current-sense operation and sends signal CS to phase controller 210.

In an embodiment of the present disclosure, the current-sense block of a power stage sends the sensed inductor-current information to phase controller 210 in the form of a current that can be of either the same magnitude as the inductor-current or (more typically) be a scaled-down version (in terms of magnitude) of the inductor-current. Correspondingly, in the embodiment, phase controller 210 is designed to receive the information in the form of a current, with the scaling factor being known to phase controller 210 as well as the (corresponding) power stage when scaling is used.

Signal PWM is an input to an SPS from phase controller 210, and may be viewed as a ‘phase control signal’ that controls the operation (ON and OFF states) of the power switches in the SPS of the corresponding phase. A cycle/period of signal PWM consists of a first interval (ON-time) in which only the high-side (HS) switch of SPS is switched ON, and a second interval in which only the low-side (LS) switch of the SPS is switched ON. The PWM signal (or more typically, drive signals derived from the PWM signal) controls the opening and closing of high-side switch and low-side switch of the SPS.

In an embodiment of the present disclosure, phase controller 210 employs a constant-ON-time control technique to generate Va. Accordingly, in such an embodiment, signal PWM is a variable frequency, fixed pulse-width (constant-ON-time) signal (i.e., pulse-frequency modulated signal), although the acronym PWM is still used herein to refer to such a signal for case of reference). The frequency of the signal is generally proportional to the desired regulated voltage (Va) and the load-current.

In an alternative embodiment, phase controller 210 may dynamically adjust the ON-time based on magnitudes of input voltage (Vin), Va and load-current such that the switching frequency is kept fairly constant over input voltage range. Such a control technique is referred to as adaptive on-time control, as is well known in the relevant arts. However, in general, signal PWM may have other characteristics depending on the specific implementation details of power supply 110.

In yet another embodiment, signal PWM can change between a constant-ON-time variable-frequency signal and a fixed-frequency pulse-width modulated signal, based on load-current requirements, desired efficiency of power supply 110 and other considerations, as would be apparent to one skilled in the relevant arts.

As is well known in the relevant arts, the PWM signals to each SPS of a same multi-phase voltage regulator are staggered/interleaved, i.e., delayed with respect to each other in phase such that typically no two high-side switches in the converter (i.e., respective SPSs) will be turned-ON at the same time instant. Such a technique is employed for reasons such as, for example, to ensure that the peak instantaneous current drawn from Vin is relatively low at all times, efficiency, reduced ripple in the output voltage, etc.

When logic LOW is detected by the SPS on signal PWM, the low-side switch is turned ON, and when logic HIGH is detected on signal PWM, the high-side switch is turned ON. Upon detecting a high-impedance (hi-Z) state (typically mid-rail voltage between power supply and ground) on signal PWM the SPS turns OFF both its high-side and the low-side switches. Thus, an SPS is said to be ‘active’ when the corresponding PWM signal is toggling between the HIGH and LOW states thereby contributing to generation of the output voltage and current, and is said to be ‘inactive’ when the corresponding PWM signal is in hi-Z state (mid-rail voltage between logic HIGH and logic-LOW voltages). In the inactive state, the power stage does not contribute to load-current.

Phase controller 210 controls the operation of the power stages via the signals noted above to provide various functions including regulating functions to enable the generation of regulated voltages Va and Vb by the corresponding sets of power stages. Accordingly, Va and Vb are shown as being provided as inputs to phase controller 210 to enable operation of one or more feedback loops within phase controller 210 to regulate Va and Vb. Phase controller 210 also receives inductor-current information (current flowing through each of the inductors) from each of the SPSs to enable various operations such as current-mode control of voltage regulation, current limiting, short circuit protection, and balancing the currents generated by each SPS of a same rail (e.g., rail Va) so as to make the currents from each SPS substantially equal in magnitude. Phase controller 210 may additionally perform various other operations which are not noted here in the interest of conciseness.

Phase controller 210 also operates to control the power stages to reduce/increase current output based on the load demand. Further, phase controller 210 may also receive signals from CPU 120 that indicate a desired power state (e.g., PS1, PS2, etc. noted above) in which the CPU operates from time to time. In response, phase controller 210 may activate/de-activate one or more of power stages 220 depending on the power state and the load-currents.

Phase controller 210 may be designed to implement automatic phase management (APM). Accordingly, the specific number of phases activated by phase controller 210 can vary depending, for example, on the magnitude of load-current drawn from a rail (e.g., Va 240). In general, the smaller the load-current is, the lesser the number of phases activated and vice-versa. For example, phase controller 210 may maintain (in an internal memory) pre-determined load-current thresholds to determine the number of active phases. The thresholds are designed such that a given load-current requirement is met by substantially equal phase output currents, subject to the maximum current that can be provided by each individual phase.

As an example, for moderate load-currents drawn from rail Va (240), phase controller 210 may activate three power stages to generate Va (240), and maintain the other three power stages in an ‘inactive’ mode. When load-current increases from the previous value and crosses a pre-determined threshold, phase controller 210 may activate all six power stages assigned to rail Va (240). However, when load-current decreases from the previous value and falls below another pre-determined threshold, phase controller 210 may de-activate (drop or shed) two out of the three previously active power stages, thus keeping only one power stage active while maintaining the other five power stages in inactive mode.

As is well known in the relevant arts, a switching converter is operable in one of the two modes-Continuous Conduction Mode (CCM) or Discontinuous Conduction Mode (DCM). CCM refers to a mode in which the inductor-current flows continuously during the entire switching cycle. In CCM, the inductor-current is allowed to go negative. The switching converter typically operates at a fixed frequency with variable duty cycle in CCM.

DCM refers to a mode in which the inductor-current falls to zero during a portion of the switching cycle. In DCM, the inductor-current is not allowed to go negative. The low-side switch is turned OFF when the inductor-current becomes zero. This avoids reversal of inductor-current (negative current), which would otherwise pull current out of the load. Thus, inductor-current stays at zero until the high-side switch is turned ON in the next PWM cycle. In order to obtain the desired magnitude of load-current, the switching frequency is varied in DCM mode.

Typically, phase controller 210 operates the power stages in CCM for high load conditions, and in DCM for light load conditions. As used herein, ‘light load’ refers to the situation when the load presented at the output is a small fraction (e.g., less than 10%) of the maximum rated power. Phase controller 210 may maintain only a small number of power stages in the active state when operating in DCM. In an embodiment, phase controller 210 operates one power stage in the active state in DCM. Phase controller 210 operates the power stages in DCM for improved efficiency, as is well known in the relevant arts.

The phase controller may operate one of the power stages as a ‘master stage’ in a given duration, which implies that such a power stage is always included in the set of active stages even as there are additions and/or droppings of stages in that given duration. Thus, the master stage remains active in that entire (given) duration irrespective of the load-current. Phase controller 210 changes the master stage periodically based on techniques such as, for example, round-robin sequence, in order to distribute stress evenly among the power stages. Thus, even in DCM, the single active power stage is cycled over time (for example, from SPS-1 to SPS-2, etc.) for stress leveling.

The description is continued to illustrate an example implementation of a power stage according to aspects of the present disclosure.

### 4. Power Stage

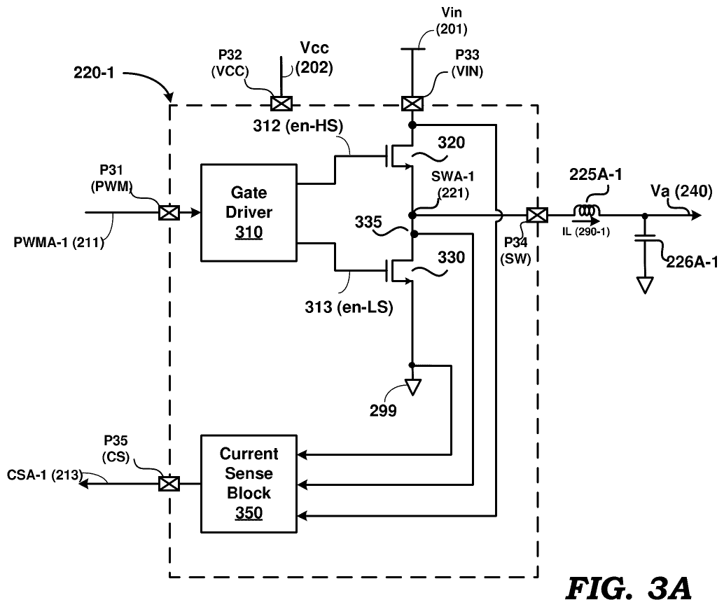

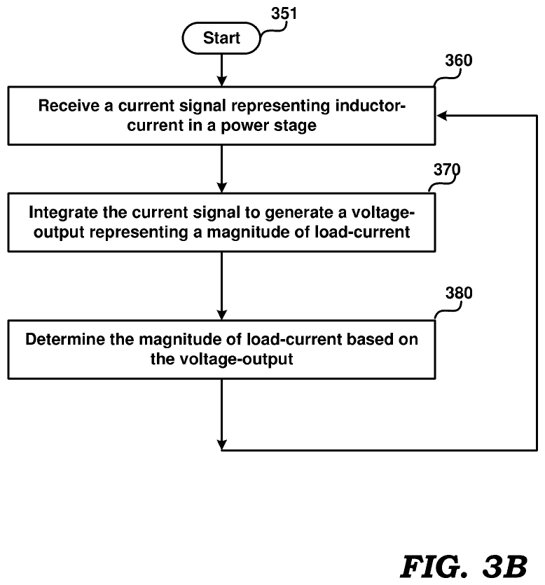

FIG. 3A is a block diagram illustrating the implementation details of a power stage in an embodiment of the present disclosure. SPSA-1 (220-1) is shown in detail in FIG. 3. The other SPSes can also be implemented to be similar to SPSA-1. SPSA-1 is shown containing gate driver 310, high-side (HS) switch 320, low-side (LS) switch 330 and current sense block 350. Also shown in FIG. 3 are inductor 225A-1 and output capacitor 226A-1. P31 through P35 represent pins PWM, Vcc, Vin, SW and CS when power stage 220 is implemented as an integrated circuit (IC). In alternative implementations (e.g., in discrete form), P31 through P35 represent corresponding circuit nodes. Vcc (202) is used to power the internal blocks of power stage 220-1. The drain terminal of HS switch 320 is connected to Vin (201), and the source terminal of LS switch 330 is connected to ground (299). Although not shown in FIG. 3A in the interest of conciseness, power stage 220 may contain various other blocks/circuits such as level-converters for gate driver 310, temperature sensors, etc.

Gate driver 310 receives a PWM signal PWMA-1 (211-1) (from phase controller 210), and in response to the logic level of the PWM signal generates the appropriate voltages to turn ON and turn OFF HS switch 320 and LS switch 330 in corresponding intervals and as indicated by the logic levels of the PWM signal. HS switch 320 and LS switch 330 are each shown implemented as an N-channel MOSFET (Metal Oxide Semiconductor Field Effect Transistor) with gate driver 310 driving the gate terminals of the MOSFETs, although other implementations for the switches having similar characteristics can benefit from the features described herein.

In the example of FIG. 3A, when PWMA-1 is a logic HIGH, gate driver 310 generates respective appropriate voltages on paths 312 (en-HS) and 313 (en-LS) to switch-ON MOSFET 320 and switch-OFF MOSFET 330. When PWMA-1 is a logic LOW, gate driver 310 generates respective appropriate voltages on paths 312 and 313 to switch-OFF MOSFET 320 and switch-ON MOSFET 330. When PWMA-1 is in a Hi-Z (High-impedance or mid-rail) state, gate driver 310 generates the respective appropriate voltages on paths 312 and 313 to switch-OFF both of MOSFET 320 and 330. It is noted here that rather than a single block, two separate gate drivers may instead be employed-one for driving the gate of the HS switch to be ON or OFF, and another for driving the gate of the LS switch to be ON or OFF. Gate driver 310 can be implemented in a known way.

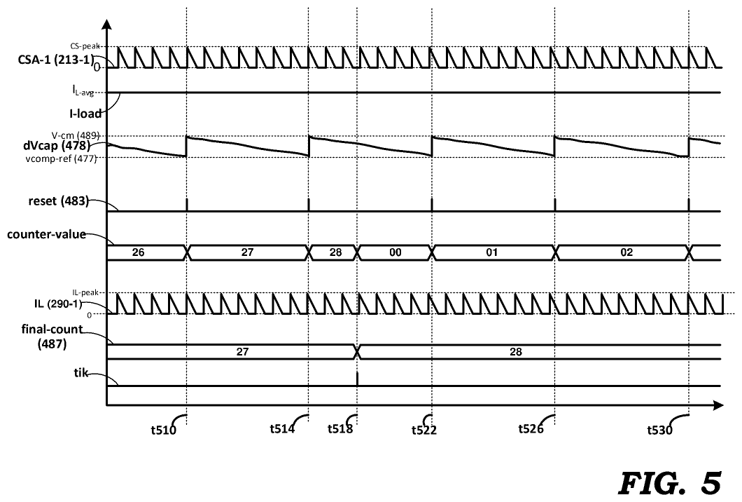

In each cycle of PWM signal, when HS switch 320 is ON, current flows from Vin to the load (connected to Va node) via HS switch 320 and inductor 225A-1 associated with SPSA-1 (220-1) with rising slope. When LS switch 330 is ON, the inductor-current flows in the loop formed by LS switch 330, inductor 225A-1 and load with falling slope. As noted above, in DCM, LS switch 330 is turned OFF when the inductor-current becomes zero, and inductor-current stays at zero until HS switch 320 is turned ON in the next PWM cycle. Thus, waveforms IL (290-1) and current signal CSA-1 (213-1) are triangular in shape, as depicted in FIG. 5.

Current-sense block 350 operates to determine the magnitude (for example, instantaneous magnitude) of the inductor-current through inductor 225A-1, and provides information indicating the inductor-current magnitude on path 213. Current-sense block 350 may determine the magnitude of the inductor-current by one of several known ways. For example, in FIG. 3A current-sense block 350 is shown as receiving respective voltage-drops across switches 320 and 330. Current-sense block 350 obtains the instantaneous magnitude of the inductor-current (or a scaled-down version thereof) based on the voltage-drops.

In an embodiment, current-sense block 350 provides/reports the inductor-current information in the form of a current signal in an analog continuous form having a magnitude that is scaled-down with respect to the instantaneous inductor-current magnitude. The term analog implies that the instantaneous magnitude is represented by non-discrete level, and the term continuous implies that the magnitude is represented instantaneously in successive time instances. In other words, the current signal is a scaled replica of the real-time waveform of the actual inductor-current. Current-sense block 350 can be implemented in a known way.

Phase controller 210 makes use of the current signal (representing the inductor-current) in operating one or more regulation feedback loop(s) to cause operation of the power switches (320 and 330) of the power stage to generate a desired regulated voltage Va as output 240. As noted above, the operation of the powers switches in the power stage is controlled by signal PWMA. Phase controller 210 generates PWMA-1 with appropriate pulse width and/or frequency to generate Va, while also achieving as high efficiency as possible. Efficiency refers to the ratio of output power delivered by the power supply to the input power drawn by the power supply from the supply source Vin.

As is well known in the relevant arts, several loss components such as switching loss (associated with switching ON/OFF of the power switches), conduction loss (voltage-drop across the power switches), dead-time loss (due to flow of current through body-diode of LS switch during dead-time interval) etc. impact the overall efficiency of a switching converter. Out of these, some of the components such as switching loss depend on the switching frequency.

In general, lower the switching frequency, lower are the switching losses in the power switches. However, the switching frequency cannot be decreased arbitrarily since sufficiently high switching frequency is required in order to supply the load-current. Higher the load-current, larger the switching frequency needs to be. Therefore, accurate determination of the load-current can enable accurate determination of the correct switching frequency for obtaining maximum efficiency.

VRM 100 typically caters to a wide range of load-currents (˜0-1600 Amperes (A)). Conventional current measurement techniques in phase controller 210 are therefore typically designed for covering wide range, which results in low accuracy.

In DCM, the load-current range (˜0-5 A) is many-fold smaller than the total rated range, and it is also required to measure the load-current as accurately as possible to obtain high efficiency. Thus, the conventional measurement techniques employed in phase controller 210 may not be suited for measurement of load-current with the desired accuracy in DCM.

Accordingly, there is a need for techniques to measure load-current under light load conditions. Phase controller 210 implemented according to aspects of the present disclosure provides measurement of load-current under light load conditions, as described below with examples.

### 5. Flow-Chart

FIG. 3B is a flow-chart illustrating the manner in which a phase controller of a multi-phase switching converter measures load-current under light load, according to an aspect of the present disclosure. The flow-chart is described with respect to the system/multi-phase switching converter of FIGS. 1 and 2 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some or all of the steps may be performed in a different sequence than that depicted below, as suited to the specific environment, as will be apparent to one skilled in the relevant arts. Many of such implementations are contemplated to be covered by several aspects of the present disclosure. The flow-chart begins in step 351, in which control immediately passes to step 360.

In step 360, phase controller 210 receives a current signal in an analog continuous form representing inductor-current in a power stage. The power stage corresponds to the single active power stage with multi-phase switching converter 110 operating in DCM. Thus, a load-current of multi-phase switching converter 110 is formed from the inductor-current of the active power stage. The current signal corresponds to signal 213 of FIG. 2.

In step 370, phase controller 210 integrates the current signal to generate a voltage-output representing a magnitude of the load-current. It may be appreciated that integrating a current signal over time provides a corresponding magnitude of charge, which in turn results in a corresponding voltage-output when the charge is stored in, for example, a capacitor.

As is well known in the relevant arts, inductor-current waveform is typically triangular in shape, and the magnitude of load-current is an average value of the inductor-current. Since the current signal represents the actual inductor-current, integrating the current signal provides an estimate of the corresponding load-current. Specifically, integration of a higher load-current results in higher magnitude of charge, and therefore higher voltage-output. Thus, the voltage-output represents a magnitude of the load-current.

In step 380, phase controller 210 determines the magnitude of load-current based on the voltage-output generated in step 370. The load-current magnitude may thereafter be used by phase controller 210 to drive the power stages. For example, phase controller 210 may vary the ON-time of PWMA-1 based on the magnitude of the load-current. Accurate determination of the load-current can enable accurate determination of the correct ON-time for obtaining maximum efficiency. Changing ON-time may in turn result in a corresponding change in the switching frequency, depending, for example, on the design of the control loop in phase controller 210.

Thus, the phase controller of the present disclosure operates to measure load-current under light load. The implementation details of a phase controller that performs such measurement in an embodiment of the present disclosure are provided next.

### 6. Phase Controller

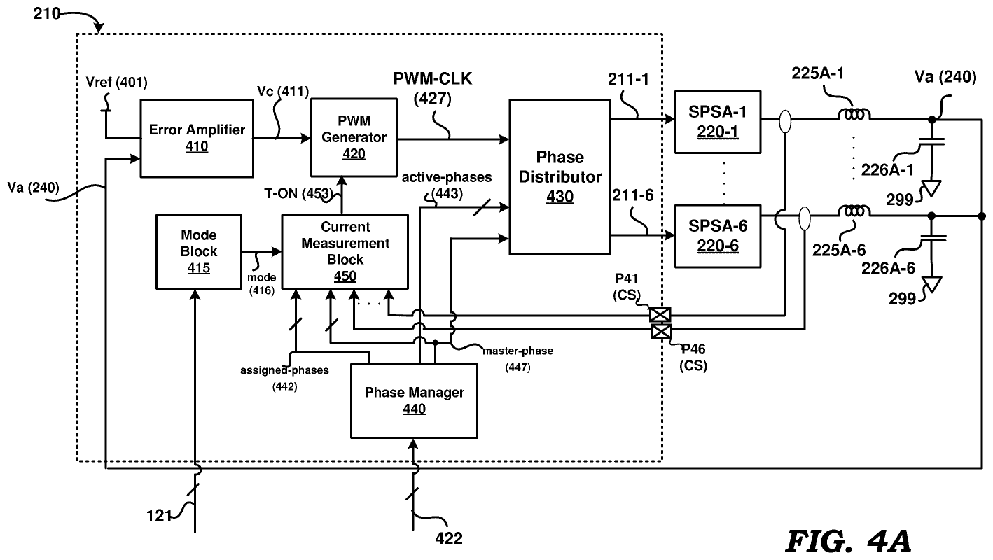

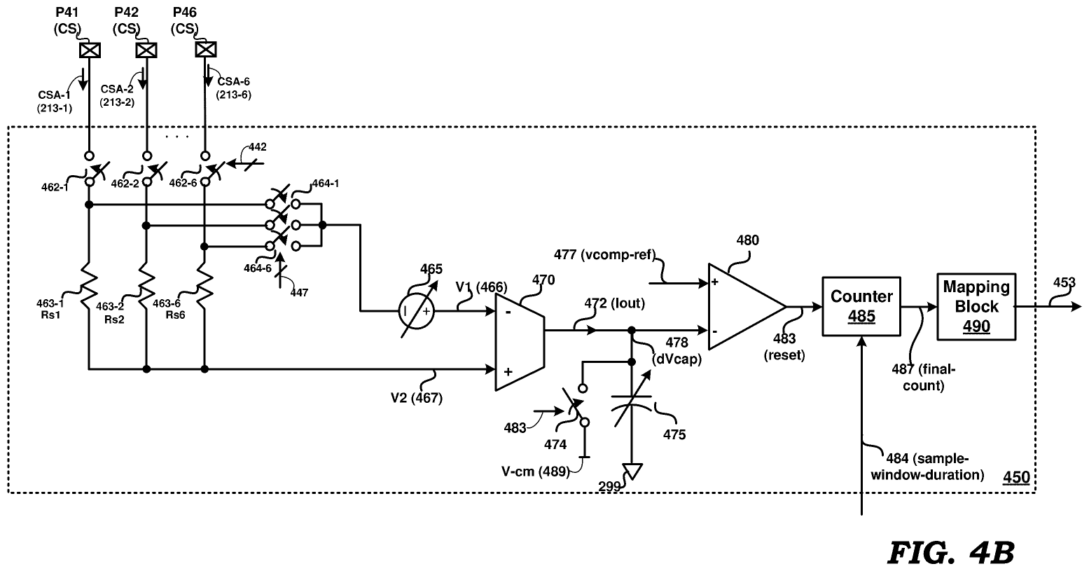

FIG. 4A is a block diagram illustrating the implementation details of a phase controller in an embodiment of the present disclosure. Phase controller 210 is shown as containing error amplifier 410, mode block 415, PWM generator 420, phase distributor 430, phase manager 440 and current measurement block 450. Also shown in FIG. 4A for the purpose of case of understanding and clarity are the power stages 220-1 through 220-6, and the corresponding inductors and capacitors. Only the 6-phase converter containing power stages SPSA-1 (220-1) through SPSA-6 (220-6) together generating voltage Va (240), and the corresponding portions of phase controller 210 required for generating voltage Va (240) are depicted in FIG. 4A for case of understanding. P41 through P46 respectively represent pins CS from the six SPSs SPS-1 through SPS-6 when phase controller 210 is implemented as an integrated circuit (IC). In alternative implementations (e.g., in discrete form), P41 through P46 represent corresponding circuit nodes.

Also, it is noted herein that only components as relevant to the understanding of the disclosure are depicted in FIG. 4A. It is understood that phase controller 210 can contain more or fewer blocks than those shown in FIG. 4A. Further, phase controller 210 is described and illustrated as employing current-mode control technique merely for illustration. However, it must be understood that phase controller 210 can employ other types of control techniques. The internal blocks of phase controller 210 may be powered by a source, not shown.

Mode block 415 receives signals from CPU 120 on path 121, determines the desired power state based on signal 121, and generates signal ‘mode’ on path 416 indicating whether SPS(s) are to be operated in CCM or DCM. In an embodiment, mode block 415 generates logic HIGH on path 416 if signal 121 indicates power states PS2 and PS3 (low power states), and a logic LOW otherwise. In an alternative embodiment, mode block 415 may receive load-current information (on corresponding path) and determine whether multi-phase switching converter 110 is to be operated in CCM or DCM based on the magnitude of load-current. In such an embodiment, mode block 415 generates logic HIGH on path 416 if load-current is less than a pre-determined threshold magnitude, and a logic LOW otherwise. The threshold may either be pre-programmed in non-volatile memory in phase controller 210 or may be received as user input via corresponding means (not shown). Mode block 415 can be implemented in a known way.

Vref represents the desired target voltage to be supplied at node Va (240). Thus, Vref represents a stable reference DC voltage which is generated internally in phase controller 210 in a known way. Error amplifier 410 receives reference voltage Vref (401), output voltage, Va (240) (or alternatively, some fraction of Va using a voltage divider network) and generates voltage Vc (411) representing the difference between voltages Vref (401) and Va (240), that forms one input to PWM generator 420. Error amplifier 410 may be implemented in a known way. Current measurement block 350 processes the sensed inductor-current flowing through the inductor(s) of the active power stage(s) in DCM to generate a duration of T-ON on path 453, that forms another input to PWM generator 420.

PWM generator 420 generates signal PWM-CLK (427) based on signals Vc and I-load-value. PWM-CLK (427) may be a sequence of pulses (for example, of fixed pulse-width), and whose frequency may be variable based on changes in Vin, Vout and load-current.

Signal PWM-CLK (427) is typically a short pulse of a fixed duration and clocks components (such as flip-flops) inside phase distributor 430. Blocks 410 and 420 may together be viewed as a ‘master-control-signal generator’ designed to generate ‘common control signal’ PWM-CLK (427) such that voltage Va (240) is maintained at the desired constant magnitude as indicated by Vref (401).

PWM generator 420 may internally contain components (not shown in FIG. 4A) such as sawtooth waveform generator, comparators, etc. required to generate signal PWM-CLK (427), as is also well known in the relevant arts. PWM generator 420 can be implemented in a known way.

Phase manager 440 receives input(s) on path 422 representing the load-current requirement, sensed inductor-currents of each power stage, overshoot/undershoot of voltage Va (240), etc., and generates signal assigned-phases on path 442, active-phases on path 443 and master-phase on path 447. Phase manager 440 controls the addition or shedding of phases (and therefore power stages) based on load-current requirement.

In an embodiment, each of signals assigned-phases (442), active-phases (443) and master-phase (447) is n bits wide, ‘n’ being the total number of phases in multi-phase switching converter 110. Thus, each bit of signals assigned-phases, active-phases and master-phase corresponds to a power stage. Signal ‘assigned-phases’ represents the phases that are assigned to a particular rail, and signal ‘active-phases’ represents the particular ones of the phases assigned to the rail that are activated to support load-current requirement of the rail in a given duration. Signal ‘master-phase’ represents the power stage that is operated as the master stage in the duration. Phase manager 440 can be implemented in a known way.

Phase distributor 430 (PD 430) receives signal PWM-CLK (427), signal active-phases (443), and generates PWM signals (211-1 through 211-6) timed according to transitions of signal PWM-CLK. PD 430 may internally contain T-ON generators (not shown in FIG. 4A) for employing constant ON-time control technique. Thus, in the illustrative embodiment, PD 430 generates PWM signals (211) having a pre-determined (constant) ON-duration (logic HIGH duration), but whose frequency may vary as noted above. Aspects of the present disclosure are equally applicable for adaptive ON-time technique noted above, as will be apparent to a skilled practitioner by reading the disclosure herein. PD 430 can be implemented in a known way.

Current measurement block 450 receives sensed inductor-current information (current signals on path 213) from SPSs SPS-1 through SPS-6, signal assigned-phases on path 442 and signal master-phase on path 447, and generates a magnitude of T-ON duration on path 453.

The description is continued to illustrate an example implementation of current measurement block that operates to measure load-current, in an embodiment of the present disclosure.

### 7. Current Measurement Block

FIG. 4B is a diagram illustrating the implementation details of a current measurement block in an embodiment of the present disclosure. Current measurement block 450 is shown containing sense resistors Rs1 through Rs6, switches 462-1 through 462-6, switches 464-1 through 464-6, calibration block 465, transconductance amplifier 470, capacitor 475, switch 474, comparator 480, counter 485 and mapping block 490. P41 through P46 respectively represent CS pins for receiving current signals 213 (sensed-current information) from SPS-1 through SPS-6 (of FIG. 2). In the illustrative embodiment, it is assumed that all six power stages (SPS-1 through SPS-6) are assigned to rail-A, and only SPS-1 is active in DCM in the duration of interest. The internal blocks of current measurement block 450 may be powered by a source, not shown. Only components as relevant to measurement of load-current in DCM are depicted in the Figure. It is understood that current measurement block 450 can contain more or fewer blocks than those shown in FIG. 4B.

Each of switches 462-1 through 462-6 is operable to be closed or open based on the logic state of respective bits of signal 442. In an embodiment, when signal 442 [x] is a logic HIGH, switch 462-X is closed, and open otherwise. Each of switches 464-1 through 464-6 is operable to be closed or open based on the logic state of respective bits of signal 447. In an embodiment, when signal 447 [x] is a logic HIGH, switch 464-X is closed, and open otherwise. Though not shown in FIG. 4B, each of switches 462-1 through 462-6 and 464-1 through 464-6 are closed/open based on logic state of signal 416 (mode). Specifically, the switches may be closed only when both signal 416 and the respective bit (in signals 442 or 447) corresponding to the switch are logic HIGH.

Calibration block 465 operates to correct for offset errors of transconductance amplifier 470 as well as gain error. Offset error refers to a non-zero output current for equal magnitude of voltages V1 and V2 and/or due to unequal bias currents of the input transistors inside amplifier 470. Calibration block 465 is a voltage source connected in the path of the inverting input of amplifier 470, and the magnitude of the voltage source is tuned to cancel the offset errors. Gain error is corrected by tuning the capacitance of capacitor 475 via suitable means.

Calibration block 465 can be implemented in a known way.

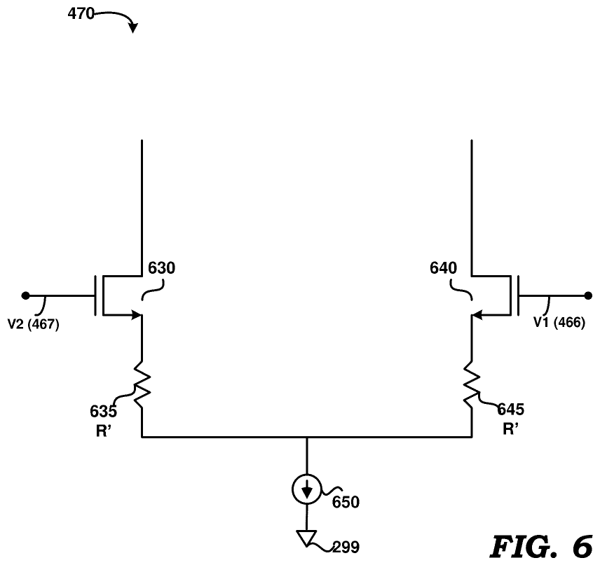

Transconductance amplifier 470 receives voltage-drop across resistor 463-1 (differential voltage) at the input terminals and generates a current (Iout, 472) proportional to the voltage-drop. An example implementation of gain-stage of amplifier 470 is described with respect to FIG. 6.

Switch 474 is operable to be closed or open based on the logic state of signal 483 (reset). In an embodiment, when signal 483 is asserted, switch 474 is closed, and is open otherwise. Switch 474 is connected between the top terminal of capacitor 475 and a reference voltage (V-cm, 489).

Capacitor 475 is charged (to V-cm) when switch 474 is closed. Capacitor 475 is discharged due to flow of current Iout in each PWM cycle, resulting in corresponding voltage-change across the capacitor. Thus, amplifier 470 and capacitor 475 may together be viewed as ‘integrator block’. The bottom terminal of capacitor 475 is connected to ground (299).

In an embodiment, V-cm equals mid-rail voltage (˜1.7V). Configuring V-cm at mid-rail voltage may enable the integrator block to operate in a linear region. However, in alternative embodiments, V-cm may be configured to a voltage other than mid-rail voltage (e.g., ground potential, 0V), as will be apparent to a skilled practitioner by reading the disclosure herein. It is noted herein that magnitudes of voltages referred to in the description are with respect to ground (0V) unless stated otherwise.

Comparator 480 receives a voltage (dVcap, 478) (voltage at the top terminal of capacitor 475) at the inverting input, and a threshold voltage vcomp-ref (477) at the non-inverting input. When magnitude of dVcap falls below magnitude of threshold voltage vcomp-ref, comparator output trips, and signal 483 is asserted. Voltage vcomp-ref may be derived from Vcc (202) in a known way, for example, by using a voltage-divider network. The manner in which the magnitude of vcomp-ref is determined in an embodiment of the present disclosure is described below in further detail. Comparator 480 can be implemented in a known way.

Counter 485 receives signal ‘reset’ on path 483, magnitude of sample-window-duration on path 484, and generates final-count on path 487. Counter 485 operates to count the number of occurrences of assertions of signal ‘reset’ bounded by a sampling window having a magnitude of duration 484. Each time signal ‘reset’ is asserted, a counter-value of the counter is incremented by 1. Counter 485 internally contains a timer (not shown in the Figure) that ticks synchronous with the end of a time duration of magnitude equal to value received on path 484. Counter 485 outputs the current count-value on path 487 at every tick of the timer, and resets the counter-value to zero. Magnitude of the sampling-window-duration 484 may be programmed by user within phase controller 210 in a known way. Counter 485 can be implemented in a known way.

Mapping block 490 receives signal ‘final-count’ on path 487 and generates the magnitude of T-ON duration on path 453. In an embodiment, mapping block 490 internally contains a look-up table (LUT) having a mapping of ‘final-count’ ranges to respective T-ON durations. The LUT may be received as user input (via corresponding means not shown), or may be configured at design in a known way.

In an alternative embodiment, the LUT may contain mapping of final-count ranges to respective magnitudes of a control parameter other than T-ON (e.g., peak value of inductor current) based on the control scheme implemented in phase controller 210. In yet another alternative embodiment, mapping block 490 may not be included in circuit 450, and final-count 487 may be provided on path 453, which may be used by PWM generator 420 or any other block in phase controller 210 for further processing.

Though the illustrative embodiment depicts mapping block 490 as being part of current measurement block 450, mapping block 490 may be implemented to be part of PWM generator 420 instead. In such an implementation, ‘final-count’ value is provided on path 453, and PWM generator 420 may use the LUT to map final-count to a corresponding T-ON duration/peak inductor current, and generates signal 427 with corresponding characteristics. Mapping block 490 can be implemented in a known way.

In operation, with all six power stages assigned to rail-A, switches 462-1 through 462-6 are closed, and with only SPS-1 active, switch 464-1 is closed while switches 464-2 through 464-6 are open. Current flowing on path 213-1 causes a corresponding voltage-drop across sense resistor Rs1 (463-1). The resulting voltage-drop is provided as differential input to amplifier 470 that generates a corresponding current output, Iout, on path 472. Iout discharges capacitor 475.

Thus, in each switching cycle, ‘integrator block’ (amplifier 470 and capacitor 475) integrates current signal 213, resulting in a corresponding decrease in magnitude of voltage dVcap due to discharging of capacitor 475. Magnitude of dVcap is compared to threshold voltage vcomp-ref, and when the comparator trips (asserting signal ‘reset’), switch 474 is closed, capacitor 475 is charged (to V-cm), and the integration resumes.

The duration bounded by two consecutive comparator trip events represents the time taken for a voltage-change across capacitor 475 of magnitude ‘vqref’. The parameters ‘qref’, ‘vqref’, gm (transconductance) of amplifier 470, capacitance of capacitor 475, resistance values of sense resistors 463 are designed such that voltage ‘dVcap’ reaches threshold value ‘vcomp-ref’ over more than one switching cycle. The number of trips in a long (as compared to the magnitude of period of PWM signal) sampling window (˜ milli-seconds) is counted. The number of trips is proportional to the magnitude of the load-current. Larger the number of comparator trips per sampling window, higher is the load-current and vice versa. Also, larger the sampling window duration, higher is the accuracy of load-current measurement.

Although the illustrative embodiment describes operation of current measurement block 450 with only one active power stage in DCM for ease of understanding, aspects of the present disclosure are equally applicable when more than one power stage is active in DCM, as will be apparent to a skilled practitioner by reading the disclosure herein. For example, if multiple power stages are active in DCM, then sensed current from each active power stage may be summed up (via corresponding means) and the voltage-drop across a single sense resistor may be coupled as the differential input of amplifier 470. Alternatively, individual current signals may be passed through respective amplifiers, and the output of amplifiers may be integrated via corresponding capacitors.

The description is continued to illustrate setting of the design parameters noted above.

### 8. Setting Design Parameters

The variables used in equations governing selection of components and design parameters are first listed below for convenience:
tsw: period of one switching cycle (PWM cycle)
ton: duration for which the HS switch is ON in a PWM cycle
toff: duration for which the LS switch is ON in a PWM cycle
qref: Reference change in charge in capacitor 475
treset: duration between two consecutive reset events
tm: sampling window which is kept much longer than treset
vqref: Voltage-change across capacitor 475 corresponding to change in charge qref
Ics: instantaneous magnitude of current signal CSA-1
indsw (t): instantaneous magnitude of actual inductor-current flowing through inductor 225A-1
dqsw: magnitude of charge delivered by SPS-1 in one switching cycle
gm: magnitude of transconductance of amplifier 470
Vin: magnitude of input voltage
Vout: magnitude of rail voltage (e.g., Va)
dvsw: voltage-change across capacitor 475 in one switching cycle
Rs: magnitude of resistance of sense resistor 463-1
iout: magnitude of current output of amplifier 470
*: multiplication symbol

### Selection of Components and Design Parameters

The value of Rs may be selected such that the resulting voltage-drop across Rs due to current signal 213 conforms to the input voltage swing range of amplifier 470 while at the same time ensuring that the entire range of inductor-current in DCM (e.g., 0-5 A) is covered. Ideally, Rs may be selected such that full-scale range of amplifier 470 is supported.

For example, assume that current signal received on path CSA-1 is scaled-down by a ratio of 10-5 (i.e., 10 micro-Amperes/Ampere (uA/A)). Thus, a magnitude of 1 A of inductor-current is represented by a magnitude of 10 uA of current signal. Based on expected parameters such as maximum load-current, range of switching frequencies, other loss components, etc. Rs may be determined. In an embodiment, Rs equals 50002.

The manner in which some of the other component values/settings are selected is illustrated below.

Charge delivered by SPS-1 in one switching cycle:

$$dqsw = {\int }_{0}^{tsw} indsw ( t ) * dt \qquad Equation ( 1 )$$

$$Average load - current in tm duration = \frac{1}{tm} * {\int }_{0}^{tm} \frac{dqsw}{fsw} * dt \qquad Equation ( 2 )$$

$$Voltage - change across capacitor 475 in one switching cycle = dvsw = {\int }_{0}^{tsw} \frac{iout ( t )}{C} * dt \qquad Equation ( 3 )$$

$$iout ( t ) = indsw ( t ) * Ri * gm \qquad Equation ( 4 )$$

$$Equation ( 5 )$$

$$Ri = Kisps * Rs ; where Kisps is the SPS current gain in [ A / A ] .$$

$$From equations ( 1 ) , ( 3 ) and ( 4 ) \text{:} dvsw = dqsw * \{ ( Ri * gm ) / C \} \qquad Equation ( 6 )$$

$$From equations ( 2 ) and ( 6 ) \text{:} Average load - current in tm duration = \frac{1}{tm} * {\int }_{0}^{tm} \frac{dqsw}{tsw} * \frac{C}{Ri * gm} * dt \qquad Equation ( 7 )$$

It may be appreciated that due to limited voltage headroom at circuit level, it may not be possible to accurately measure dvsw over tm. Therefore, the integrator is reset periodically, and the number of such reset events is counted over tm to get an estimate of average load-current. Thus,

$$Average load - current in a sampling window \approx \frac{1}{tm} * \frac{C}{Ri * gm} * \sum \frac{vqref}{treset} * number of reset events ;$$

$$where$$

$$vqref = {\int }_{0}^{treset} \frac{dvsw}{tsw} * dt$$

The magnitudes of gm and C may be selected based on factors such as input voltage range of comparator 480, whether capacitor 475 is to be implemented on-chip, and if so, area constraints on the chip, etc., and any other practical considerations such as sampling window duration, etc. In an embodiment, C equals 5 pico-Farads (pF), and ‘gm’ equals 10 micro-Siemens (uS). Any suitable combination of magnitudes gm and C may be selected based on the particular implementation of current measurement block 450, as will be apparent to a skilled practitioner by reading the disclosure herein.

It may be appreciated that integrator block is designed for a particular combination of magnitudes gm and C. Variations in the magnitudes may lead to inaccurate measurement of load-current. Thus, if the magnitude of gm were to change to gm′ (e.g., due to PVT variations), then the magnitude of C may be correspondingly suitably tuned to C′ such that K remains substantially constant. Such tuning may minimize errors in the measurement of load-current.

Magnitude vqref is voltage-change caused across capacitor 475 corresponding to change in charge in capacitor 475 by magnitude qref. vqref is configured as threshold voltage (vcomp-ref, 477) at non-inverting input of comparator 480.

Magnitudes ‘qref’, ‘vcomp-ref’ and sampling window duration may be suitably chosen such that voltage across capacitor reaches vqref over multiple (e.g., ˜10) switching cycles, and the number of comparator trip events in a sampling window is neither too small nor too large. In general, magnitudes ‘qref’, ‘vcomp-ref’, C and sample window duration may be so designed to have a reasonable trade-off between accuracy, quiescent current drawn by current measurement block, area constraints on the chip and measurement time as suited for the particular implementation.

As an example, consider a sample window duration of 1 milli-second, C=5 pF, gm=10 uS and qref=70 micro-Coulombs (uC). Thus, from above equations, vqref=0.7V.

Thus, a load-current of 1 A will cause delivery of 70 uC of charge in 70 us, while a load-current of 5 A will cause delivery of the same magnitude of charge (70 uC) in 14 us. Accordingly, a load-current of 1 A will cause around 14 comparator trips in the Ims sampling window, while a load-current of 5 A will cause around 70 comparator trips in the Ims sampling window. Thus, the number of comparator trips is directly proportional to the magnitude of the load-current. In other words, higher the load-current, steeper will be the slope of waveform dVcap plotted with respect to time with dVcap reaching vcomp-ref quicker, and accordingly higher will be the number of comparator trips in the sampling window, and vice versa.

The manner in which a magnitude of load-current is measured using the above design parameters is illustrated next.

### 9. Measuring Load-Current

FIG. 5 is a timing diagram (not to scale) illustrating example waveforms of some signals and voltages at some nodes of a phase controller in an embodiment of the present disclosure. FIG. 5 depicts example waveforms of signals CSA-1 (213-1), load-current (I-load), voltage dVcap (478) at inverting input of comparator 480, signal reset (483), counter-value, inductor-current (290-1), signal final-count (487) and signal tik. Signals ‘counter-value’ and ‘tik’ are generated internal to counter 485. Signal counter-value represents the instantaneous value of the counter counting the number of assertions of signal ‘reset’. Signal ‘tik’ is asserted synchronous with the end of the duration of the sampling window noted above. I-load (having a magnitude IL-avg) represents the load-current drawn at node Va.

SPS-1 is the only active power stage and is operating in DCM under steady-state. The corresponding inductor-current IL (290-1) and current signal (CSA-1) are shown in the Figure. The inductor-current is shown having a peak magnitude of IL-peak and the current signal is shown having a peak magnitude of CS-peak. Magnitude of V-cm equals 1.7V and magnitude of vcomp-ref equals IV.

Just prior to time t510, it is assumed that counter-value is 26. At t510, voltage dVcap falls below comparator threshold voltage vcomp-ref. As a result, comparator 480 trips, and asserts signal 483. When signal 483 is asserted, switch 474 is closed, thereby charging capacitor 475. Thus, at t510, dVcap is reset to V-cm.

Also, when signal 483 is asserted, counter 485 increments count-value by 1. Thus, counter-value is shown to be incremented from 26 to 27 at t510.

In the time interval t510-t514, integration of current signal 213 continues, resulting in discharging of capacitor 475. Due to voltage (V1) at inverting input of amplifier 470 being of a higher magnitude than voltage (V2) at non-inverting input, in each PWM cycle, voltage dVcap decreases by a magnitude corresponding to the amount of charge delivered in that cycle. In alternative embodiments, the inputs to amplifier 470 may be interchanged, and corresponding adjustments to comparator inputs may be implemented, as will be apparent to a skilled practitioner by reading the disclosure herein. Magnitude of dVcap decreases in each PWM cycle, and falls below vcomp-ref at t514.

At t514, signal 483 is asserted, switch 474 is closed, capacitor 475 is charged to V-cm, counter-value is incremented to 28, and integration continues. Thus, in a duration (t510-t514 in the Figure) bounded by two consecutive comparator trip events, voltage change across capacitor equals vqref (here, 0.7V), corresponding to reference charge, qref (here 70 uC).

At t518, counter 485 asserts signal ‘tik’ synchronous with end of sampling window (here, assumed to be 1 milli-second). When ‘tik’ is asserted, the current counter-value (here 28) is output on path final-count. It may be appreciated that the time instance of end of sampling window may or may not coincide with reset signal assertion. In other words, duration of sampling window may not be equal to an integral multiple of reset event durations. However, it will result in a negligible error in determination of load-current magnitude.

Mapping block 490 determines from the LUT that a count of 28 maps to a corresponding T-ON duration, and provides the T-ON duration on path 453. As noted above, around 14 trips correspond to load-current magnitude of 1A. Thus, 28 trips correspond to load-current magnitude of 2A.

An example implementation of a portion of transconductance amplifier in an embodiment of the present disclosure is provided next.

### 10. Transconductance Amplifier

FIG. 6 is a diagram illustrating the implementation details of differential gain stage of a transconductance amplifier, in an embodiment of the present disclosure. Transconductance amplifier 470 is shown containing NMOS transistors 630 and 640, resistors 635 and 645, each having resistance value of R′, and current source 650. Transistors 630 and 640 are shown receiving respective voltages V2 (467) and V1 (466) at the gate terminals.

In an embodiment, resistors Rs (463) and R′ (645) are matched (for example, Rs and R′ will be on the same chip when current measurement block is implemented as part of phase controller IC) such that Rs and R′ track each other. Thus, PVT (process voltage and temperature) variation of gain (“gm*Rs”) of amplifier 470 is very less, thereby minimizing errors in the measurement of load-current.

Thus, aspects of the present disclosure operate to provide measurement of load-current under light loads.

### 11. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 3A, 4A, 4B and 6 although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-channel MOS) transistors, while also interchanging the connections to power and ground terminals.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A multi-phase switching converter to provide a regulated supply voltage from an input voltage in a light load condition, said multi-phase switching converter comprising:
a power stage coupled to receive a phase control signal and to drive an inductor to cause flow of an inductor-current according to said phase control signal, wherein a load-current of said multi-phase switching converter is formed from said inductor-current; and
a phase controller coupled to receive a current signal from said power stage, said current signal being in an analog continuous form to represent said inductor-current in said power stage, said phase controller configured to:
integrate said current signal in said analog continuous form to generate a voltage-output representing a magnitude of said load-current; and
determine said magnitude of said load-current based on said voltage-output.

2. The multi-phase switching converter of claim 1, wherein said phase controller comprises:
a pin at which said current signal is received from said power stage;
a master-control-signal generator block coupled to receive said regulated supply voltage, a first reference voltage of a desired magnitude, and a magnitude of ON-time of said phase control signal, and to generate a common control signal with corresponding characteristics;
a phase distributor coupled to receive said common control signal and to generate said phase control signal timed according to transitions of said common control signal; and
a current measurement block coupled to receive said current signal and to determine said magnitude of said load-current, wherein said current measurement block comprises:
an integrator block coupled to receive said current signal and to provide said voltage-output; and
a processing block coupled to receive said voltage-output, determine said magnitude of said ON-time based on said magnitude of said voltage-output and to provide said magnitude of said ON-time to said master-control-signal generator block.

3. The multi-phase switching converter of claim 2, wherein said current measurement block comprises a first resistor coupled between said pin and said integrator block,
wherein said integrator block comprises:
a transconductance amplifier characterized by a transconductance value (gm), said transconductance amplifier coupled to receive a voltage-drop across said first resistor as a differential input and to generate from an output node an output-current proportional to a magnitude of said voltage-drop, said voltage-drop caused due to flow of said current signal via said first resistor;
a capacitor having a first terminal and a second terminal, wherein said first terminal of said capacitor is coupled to said output node, wherein said second terminal of said capacitor is coupled to a constant reference potential, said capacitor characterized by a capacitance value, said capacitor coupled to receive said output-current of said transconductance amplifier and to provide said voltage-output at said first terminal;
wherein said processing block comprises:
a comparator to compare a magnitude of a voltage at said first terminal of said capacitor with a threshold voltage, wherein said comparator asserts a reset-signal when said magnitude of said voltage at said first terminal falls below said threshold voltage;
a counter coupled to receive said reset-signal and to generate a count of a number of times said reset-signal is asserted in a sampling window; and
a mapping block coupled to receive said count and to map said count to a corresponding magnitude of said ON-time,
wherein said threshold voltage is proportional to a pre-determined quantum of change in magnitude of charge in said capacitor,
wherein a duration of said sampling window is selected to be greater than the amount of time required for change in voltage at said first terminal of said capacitor by said threshold voltage.

4. The multi-phase switching converter of claim 3, wherein said current signal is a scaled version of said inductor-current with said inductor-current being scaled by a scaling factor to obtain said current signal.

5. The multi-phase switching converter of claim 4, wherein said mapping block comprises a look-up table containing a plurality of entries to perform said mapping, wherein each entry of said plurality of entries contains a range of said count and a respective magnitude of said ON-time.

6. The multi-phase switching converter of claim 4, wherein said integrator block further comprises a switch coupled across said capacitor, said switch operable to be closed when said reset-signal is asserted, where a first terminal of said switch is coupled to said output node, wherein a second terminal of said switch is coupled to a second reference voltage, wherein when said switch is closed, voltage across said capacitor equals said second reference voltage.

7. The multi-phase switching converter of claim 5, wherein said capacitance value of said capacitor is tunable to offset any variation in a magnitude of gm.

8. The multi-phase switching converter of claim 7, wherein said transconductance amplifier comprises a differential gain stage comprising:
a first transistor;
a second transistor;
a second resistor having a second resistance value;
a third resistor having a third resistance value; and
a current source,
wherein a control terminal of said first transistor is coupled to a first terminal of said first resistor, wherein said control terminal of said first transistor forms a non-inverting input of said transconductance amplifier, wherein a current terminal of said first transistor is coupled a first terminal of said second resistor, wherein a second terminal of said second resistor is coupled to a first terminal of said current source, wherein a second terminal of said current source is coupled to said constant reference potential,
wherein a control terminal of said second transistor is coupled to a second terminal of said first resistor, wherein said control terminal of said second transistor forms an inverting input of said transconductance amplifier, wherein a current terminal of said second transistor is coupled to a first terminal of said third resistor, wherein a second terminal of said third resistor is coupled to a junction of said second terminal of said second resistor and said first terminal of said current source,
wherein said second resistance value equals said third resistance value,
wherein said second resistor and said third resistor are matched with said first resistor.

9. The multi-phase switching converter of claim 8, wherein said current measurement block further comprises:
a calibration block operable to correct for offset errors of said transconductance amplifier; and
a first switch coupled between said second terminal of said first resistor and said calibration block, said first switch operable to be closed when a master-stage signal is in a first logic state and to be open when said master-stage signal is in a second logic state,
wherein said calibration block is coupled between said first switch and said inverting input of said transconductance amplifier,
wherein said first terminal of said first resistor is coupled to said non-inverting input of said transconductance amplifier.

10. A phase controller of a multi-phase switching converter, said multi-phase switching converter to provide a regulated supply voltage from an input voltage in a light load condition, said phase controller to provide a phase control signal to a power stage of said multi-phase switching converter, said power stage designed to connect said input voltage to an inductor when said phase control signal is in a first state and to disconnect said input voltage from said inductor when said respective phase control signal is in a second state, wherein a load-current of said multi-phase switching converter is formed from said inductor-current, said phase controller comprising:
a current-sense pin;
a master-control-signal generator block coupled to receive said regulated supply voltage, a first reference voltage of a desired magnitude, and a duration of ON-time, and to generate a common control signal with corresponding characteristics;
a phase distributor coupled to receive said common control signal and to generate said phase control signal timed according to transitions of said common control signal; and
a current measurement block coupled to receive a current signal from said power stage at said current-sense pin, said current signal being in an analog continuous form to represent said inductor-current in said power stage, wherein said current measurement block comprises:
an integrator block coupled to receive said current signal and to provide said voltage-output; and
a processing block coupled to receive said voltage-output, and determine said magnitude of said load-current based on said voltage-output.

11. The phase controller of claim 10, wherein said current measurement block comprises a first resistor coupled between said current-sense pin and said integrator block,
wherein said integrator block comprises:
a transconductance amplifier characterized by a transconductance value (gm), said transconductance amplifier coupled to receive a voltage-drop across said first resistor as a differential input and to generate from an output node an output-current proportional to a magnitude of said voltage-drop, said voltage-drop caused due to flow of said current signal via said first resistor; and
a capacitor having a first terminal and a second terminal, wherein said first terminal of said capacitor is coupled to said output node, wherein said second terminal of said capacitor is coupled to a constant reference potential, said capacitor characterized by a capacitance value, said capacitor coupled to receive said output-current of said transconductance amplifier and to provide said voltage-output at said first terminal;
wherein said processing block comprises:
a comparator to compare a magnitude of a voltage at said first terminal of said capacitor with a threshold voltage, wherein said comparator asserts a reset-signal when said magnitude of said voltage at said first terminal falls below said threshold voltage;
a counter coupled to receive said reset-signal and to generate a count of a number of times said reset-signal is asserted in a sampling window; and
a mapping block coupled to receive said count and to map said count to a corresponding magnitude of said ON-time,
wherein said threshold voltage is proportional to a pre-determined quantum of change in magnitude of charge in said capacitor,
wherein a duration of said sampling window is selected to be greater than the amount of time required for change in voltage at said first terminal of said capacitor by said threshold voltage.

12. The phase controller of claim 11, wherein said current signal is a scaled version of said inductor-current with said inductor-current being scaled by a scaling factor to obtain said current signal.

13. The phase controller of claim 12, wherein said mapping block comprises a look-up table containing a plurality of entries to perform said mapping, wherein each entry of said plurality of entries contains a range of said count and a respective duration of said ON-time.

14. The phase controller of claim 12, wherein said integrator block further comprises a switch coupled across said capacitor, said switch operable to be closed when said reset-signal is asserted, where a first terminal of said switch is coupled to said output node, wherein a second terminal of said switch is coupled to a second reference voltage, wherein when said switch is closed, voltage across said capacitor equals said second reference voltage.

15. The phase controller of claim 13, wherein said capacitance value of said capacitor is tunable to offset any variation in a magnitude of gm.

16. The phase controller of claim 15, wherein said transconductance amplifier comprises a differential gain stage comprising:
a first transistor;
a second transistor;
a second resistor having a second resistance value;
a third resistor having a third resistance value; and
a current source,
wherein a control terminal of said first transistor is coupled to a first terminal of said first resistor, wherein said control terminal of said first transistor forms a non-inverting input of said transconductance amplifier, wherein a current terminal of said first transistor is coupled a first terminal of said second resistor, wherein a second terminal of said second resistor is coupled to a first terminal of said current source, wherein a second terminal of said current source is coupled to a constant reference potential,
wherein a control terminal of said second transistor is coupled to a second terminal of said first resistor, wherein said control terminal of said second transistor forms an inverting input of said transconductance amplifier, wherein a current terminal of said second transistor is coupled to a first terminal of said third resistor, wherein a second terminal of said third resistor is coupled to a junction of said second terminal of said second resistor and said first terminal of said current source,
wherein said second resistance value equals said third resistance value,
wherein said second resistor and said third resistor are matched with said first resistor.

17. The phase controller of claim 16, wherein said current measurement block further comprises:
a calibration block operable to correct for offset errors of said transconductance amplifier; and
a first switch coupled between said second terminal of said first resistor and said calibration block, said first switch operable to be closed when a master-stage signal is in a first logic state and to be open when said master-stage signal is in a second logic state,
wherein said calibration block is coupled between said first switch and said inverting input of said transconductance amplifier,
wherein said first terminal of said first resistor is coupled to said non-inverting input of said transconductance amplifier.

18. A method performed in a phase controller of a multi-phase switching converter, said multi-phase switching converter configured to provide a regulated supply voltage from an input voltage in a light load condition, said method comprising:
receiving a current signal in an analog continuous form representing inductor-current in a power stage of said multi-phase switching converter, wherein said a load-current of said multi-phase switching converter is formed from said inductor-current;
integrating said current signal to generate a voltage-output corresponding to a magnitude of said current signal; and
determining said magnitude of said load-current based on said voltage-output.
